(19) United States
(12) Patent Application Publication
(10) Pub. No.: US 2025/0315279 A1
(43) Pub. Date: Oct. 9, 2025

(54) FALLBACK USER INTERFACE IDENTIFICATION TECHNIQUES FOR AUTOMATION PROCESSES

(71) Applicant: Automation Anywhere, Inc., San Jose, CA (US)

(72) Inventors: Mrugen Anil Shah, Vadodara (IN); Rajendra Vijay, Fremont, CA (US); Gaurang Kumar Patel, Fremont, CA (US); Mayur Patel, Vadodara (IN)

(21) Appl. No.: 19/090,387

(22) Filed: Mar. 25, 2025

Related U.S. Application Data
(60) Provisional application No. 63/572,119, filed on Mar. 29, 2024.

(51) Int. Cl. G06F 9/451; G06F 40/117

(52) U.S. Cl. CPC G06F 9/451; G06F 40/117

(57) ABSTRACT

Systems and methods for locating target user interface (UI) elements that automation programs intend to interact when performing automation programs. The automation programs can, for example, operate to perform actions as part of a workflow process to complete tasks. Advantageously, when UI elements referenced in automation programs cannot be located based on information recorded about the UI elements during the phase of designing the automation programs. One approach can involve creating candidate fallback element locators (e.g., XPaths) for UI elements during the automation program design phase. If an automation program fails during playback, one or more of these candidate fallback element locators can be used to locate a target UI element. In another approach, when an automation program playback fails, portions of a software application's user interface code can be identified and used as inputs to machine learning model(s), which can generate candidate fallback element locators that can used to locate target UI elements.

### CROSS-REFERENCE TO RELATED APPLICATION

This application claims priority to U.S. Provisional Patent Application No. 63/572,119, filed Mar. 29, 2024, and entitled “FALLBACK USER INTERFACE IDENTIFICATION TECHNIQUES FOR AUTOMATION PROCESSES,” which is hereby incorporated by reference herein.

### BACKGROUND OF THE INVENTION

Process automation systems enable automation of repetitive and manually intensive computer-based tasks. In an automation system, computer software, automation programs can be created to perform tasks that would otherwise be performed by humans. Some automation programs have the capability of mimicking the actions of a person in order to perform various computer-based tasks. For instance, an automation system can interact with one or more software applications through user interfaces, as a person would do. Such automation systems typically do not need to be integrated with existing software applications at a programming level, thereby eliminating the difficulties inherent to integration. Advantageously, automation systems permit automation of application-level repetitive tasks via automation programs that are coded to repeatedly and accurately perform the repetitive tasks.

Some automation platforms operate by recording actions performed by users while using one or more software applications to process and complete tasks. For example, a recording module can record the various software applications utilized, the various user interface (UI) elements and controls that the user interacted with, and the properties of the UI elements. For software applications with web-based UI's, the UI element properties may include path, name, IDs, and other HTML or XML element properties. The UI elements that users interacted with and which are recorded are said to be captured within the recording.

Automation programs can be created based on recordings such that the automation programs, when run, will automatically, or programmatically, perform actions noted in the recordings which were previously performed by the user in order to process corresponding tasks. Up to this point, this phase of activities can be referred to a design time phase, i.e., the phase during which automation programs are created.

The created automation programs can then be run, or played back, to automatically process and complete tasks of the type that were subject of the corresponding recording. During playback, the automation programs can locate and interact with User Interface (UI) elements that allow the automation programs to perform similar or the same actions that users would have performed. Each of the UI elements that the automation programs attempt to locate can be referred to as target UI elements. Target UI elements can be located by assessing the UI element properties, e.g., the path, name, IDs, etc. within the software application users interfaces during playback. By automatically processing the tasks previously performed by the humans using automation programs, the human user is able to spend time and effort on other higher value tasks. This phase of implementing and running the automation programs is called the playback phase.

However, it is not uncommon for software application user interfaces to be updated from time to time based on aesthetic or functional reasons. For example, with such updates some UI elements might be moved to a different location, revised, or replaced with new UI elements. Also, some dynamic UI elements, properties or values may change between design time and playback. Such updates or changes may cause attempts to identify target UI elements to fail, which in turn may cause automation processes to fail. In light of such challenges, fallback mechanisms locating target UI elements would be desirable when changes in software application user interfaces make it difficult to locate such target UI elements needed for successful automation program execution.

### SUMMARY

Systems and methods for locating target user interface (UI) elements that automation programs intend to interact when performing automation programs are described. The automation programs can, for example, operate to perform actions as part of a workflow process to complete tasks. These systems and methods can be advantageously used when UI elements referenced in the automation programs cannot be located based on information recorded about the UI elements during the phase of designing the automation programs. One approach can involve creating candidate fallback element locators (e.g., web element locators, such as XPaths) for UI elements during the design of an automation program (e.g., during the design phase). The, if an automation program were to fail during playback, one or more of these candidate fallback element locators could be used to locate a particular UI element. In another approach, when an automation program playback fails, portions of a software application's user interface code can be identified and used as inputs to one or more machine learning model(s), which can generate candidate fallback element locators (e.g., web element locators, such as XPaths) that can used to locate a particular UI element. Various techniques can be used for providing such inputs and/or instructions to such one or more machine learning models.

The invention can be implemented in numerous ways, including as a method, system, device, or apparatus (including computer readable medium). Several embodiments of the invention are discussed below.

As computer-implemented method for automating a process, one embodiment can, for example, include at least: recording user actions performed on at least one software application, wherein at least some of the user actions involve interaction with a user interface (UI) control element of the at least one software application; for each of a plurality of the user actions that involves an interaction with a UI control element, generating one or more fallback element locators for the corresponding UI control element; subsequently initiating running of an automation program, wherein the automation program programmatically performs at least some of the user actions that were recorded; determining a failed automation attempt by the automation program to interact with at least one of the UI control elements of the at least one software application; retrieving at least one of the fallback element locators for the at least one of the UI control elements of the at least one software application corresponding to the failed automation attempt; and retrying, in accordance with the retrieved at least one of the fallback paths, the failed automation attempt by the automation program to interact with the at least one of the UI control elements of the at least one software application corresponding to the failed automation attempt.

As computer-implemented method for automating a process, another embodiment can, for example, include at least: recording, by a recorder module, one or more user actions performed on a software application where at least some of the user actions involve interaction with a user interface (UI) control element of the software application; for each user action that involves an interaction with a UI control element, generating, by a fallback XPath generator module, one or more fallback XPaths for the UI control element; prioritizing the one or more generated fallback XPaths according to the likelihood that each of the generated fallback XPaths correspond to a particular UI control element of the software application that the user interacted with; and storing the one or more generated fallback XPaths within a repository with or in accordance with priority information.

As computer-implemented method for automating a process, one embodiment can, for example, include at least: determining that an automation operation of an automation process has failed to identify a target user interface (UI) element within a software application user interface, wherein the automation program is configured to interact with the target UI element in order to carry out the automation operation; extracting, by a user interface code extraction module, code of the software application UI; identifying, by a relevant UI code identifying module, one or more relevant portions of the extracted code of the software application that are more likely to represent the target UI element; generating prompt messages, by a prompt generating module, that incorporate at least the identified relevant portions of the extracted code, where the prompt messages provide instructions to an XPath generating machine learning (ML) model that is configured to generate XPaths, wherein each of the generated XPaths identifies a candidate target UI element; validating, using an XPath validation module, at least one of the generated XPaths; and resuming the automation operation using at least one of the validated XPaths, wherein the automation program identifies the target UI element using the at least one of the validated XPath.

As a non-transitory computer readable medium including at least computer program code tangible stored thereon for automating a process, one embodiment can, for example, include at least: computer program code for recording user actions performed on at least one software application, wherein at least some of the user actions involve interaction with a user interface (UI) control element of the at least one software application; computer program code for generating, for each of a plurality of the user actions that involves an interaction with a UI control element, one or more fallback element locators for the corresponding UI control element; computer program code for subsequently initiating running of an automation program, wherein the automation program programmatically performs at least some of the user actions that were recorded; computer program code for determining a failed automation attempt by the automation program to interact with at least one of the UI control elements of the at least one software application; computer program code for retrieving at least one of the fallback element locators for the at least one of the UI control elements of the at least one software application corresponding to the failed automation attempt; and computer program code for retrying, in accordance with the retrieved at least one of the fallback paths, the failed automation attempt by the automation program to interact with the at least one of the UI control elements of the at least one software application corresponding to the failed automation attempt.

As a non-transitory computer readable medium including at least computer program code tangible stored thereon for automating a process, one embodiment can, for example, include at least: computer program code for recording one or more user actions performed on a software application where at least some of the user actions involve interaction with a user interface (UI) control element of the software application; computer program code for generating, for each user action that involves an interaction with a UI control element, one or more fallback element locators for the UI control element; computer program code for prioritizing the one or more generated fallback element locators according to the likelihood that each of the generated fallback element locators correspond to a particular UI control element of the software application that the user interacted with; and computer program code for storing the one or more generated fallback element locators within a repository with or in accordance with priority information.

As a non-transitory computer readable medium including at least computer program code tangible stored thereon for automating a process, one embodiment can, for example, include at least: computer program code for determining that an automation operation of an automation process has failed to identify a target user interface (UI) element within a software application user interface, wherein the automation program is configured to interact with the target UI element in order to carry out the automation operation; computer program code for extracting code of the software application UI; computer program code for identifying one or more relevant portions of the extracted code of the software application that are more likely to represent the target UI element; computer program code for generating prompt messages that incorporate at least the identified relevant portions of the extracted code, where the prompt messages provide instructions to a machine learning (ML) model that is configured to generate paths, wherein each of the generated element locators identifies a candidate target UI element; computer program code for validating at least one of the generated paths; and computer program code for resuming the automation operation using at least one of the validated paths, wherein the automation program identifies the target UI element using the at least one of the validated path.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of an automation environment according to one embodiment.

FIG. 2 illustrates a process for recording actions performed by users as they use one or more software applications to complete tasks, according to one embodiment.

FIG. 3 illustrates a process flow for playback of an automation program for situations where automation playback fails due to an inability to locate a target UI element, according to one embodiment.

FIG. 4 illustrates a flow diagram of an automation playback process that uses a Machine Learning (ML) assisted target UI identification process, according to one embodiment.

FIG. 5 is a flow diagram that illustrates operations of user instructions for an ML model for identifying HTML elements of a software application during playback of an automation program, according to one embodiment.

FIG. 6 is a screen shot of an exemplary user interface associated with a webpage.

FIG. 7 is a block diagram of an automation system according to one embodiment.

FIG. 8 is a block diagram of a robotic process automation system according to one embodiment.

FIG. 9 is a block diagram of a generalized runtime environment for bots in accordance with another embodiment of the robotic process automation system illustrated in FIG. 8.

FIG. 10 is yet another embodiment of the robotic process automation system of FIG. 8 configured to provide platform independent sets of task processing instructions for bots.

FIG. 11 is a block diagram illustrating details of one embodiment of the bot compiler illustrated in FIG. 10.

FIG. 12 is a block diagram of an exemplary computing environment for an implementation of a robotic process automation system.

### DETAILED DESCRIPTION OF CERTAIN EMBODIMENTS

Systems and methods for locating target user interface (UI) elements that automation programs intend to interact when performing automation programs are described. The automation programs can, for example, operate to perform actions as part of a workflow process to complete tasks. These systems and methods can be advantageously used when UI elements referenced in the automation programs cannot be located based on information recorded about the UI elements during the phase of designing the automation programs. One approach can involve creating candidate fallback element locators (e.g., web element locators, such as XPaths) for UI elements during the design of an automation program (e.g., during the design phase). The, if an automation program were to fail during playback, one or more of these candidate fallback element locators could be used to locate a particular UI element. In another approach, when an automation program playback fails, portions of a software application's user interface code can be identified and used as inputs to one or more machine learning model(s), which can generate candidate fallback element locators (e.g., web element locators, such as XPaths) that can used to locate a particular UI element. Various techniques can be used for providing such inputs and/or instructions to such one or more machine learning models.

Fallback techniques or mechanisms for locating target UI elements are described that are particularly desirable when changes to user interfaces of software applications occur after an automation program has been created because often the automation program has difficulty locating certain UI elements within the changed user interfaces and thus in such cases successful execution of the automation program cannot occur.

The fallback techniques or mechanisms can identify a target UI element during playback of an automation program add resiliency to automation platforms so as to increase the likelihood of properly locating target UI elements during playback in instances where the automation platform is initially unable to locate the target UI element. Instances when an automation platform is unable to locate a target UI element may be when the user interface of a software application that an automation program is executing upon has changed relative to the user interface of the same software application during automation program design time. For example, UI elements may have change locations, text labels, size, color, or other UI element parameters. Such changes may commonly occur with software updates for software applications. As another example, UI elements may change because they are dynamic in nature, e.g., certain text field values are held by dynamic variables that refresh based on various criteria.

Process automation systems can identify target UI element by reviewing an application's UI control tree. The target UI element will be unable to be found using in the control tree if any one or more properties (e.g., name, XPath, etc.) of the target UI element have changed since design time.

In one embodiment, the process automation system can utilize a native system and process to assist in identifying the target UI element. The process automation system generates one or more fallback XPaths based on the UI element that the user interacted with when a recorder module recorded a user's actions while taking such actions, including interacting with UI elements of software applications that a user is interacting with while performing actions to process a task. Each of the UI elements that a user interacts with during this time can be referred to as a UI element that the recorder module captures. The recordings saved by the recorder module can be used to assist in creating an automation program that can later be used to automatically, or programmatically, perform the same or similar actions taken by the user so that the tasks, or workflows, can be effectively and efficiently completed. This stage of recording can happen during the automation program design time, or for short, design time. According to the native system and process, multiple categories of candidate element locators (e.g., XPaths) can be created. The candidate element locators can be validated as appropriate element locators based on, for example, HTML element or object parameters of the target UI control from design time. The candidate element locators can also be validated in a priority order of confidence give to each of the categories.

In another embodiment, when an automation program fails to properly execute because the process automation system is unable to locate the target UI element, an XPath generation machine learning (ML) model can be used and prompted with instructions so that the ML model generates candidate element locators (e.g., XPaths) that can each be tested or validated to determine which of the candidate element locators are likely to identify the target UI element in a software application during playback of an automation program. Note that playback of an automation program refers to the execution of an automation program to automatically, or programmatically, perform the same or similar actions that a human user would perform to complete a task or workflow.

Also, methods and systems described herein can involve identifying or receiving a user request for the production of an automation program and then utilizing one or more machine learning models. Each of the machine learning models can produce an aspect of the requested automation program. Each of the machine learning models can also be provided with inputs such as a specific user's request for an automation program to automate tasks, the definition of a role that the model should take on, domain knowledge specific to an aspect of the automation program being requested, and functional instructions for each of the machine learning models to produce a desired output. The outputs of each of the machine learning models can be combined to form the user-requested automation program. Advantageously, automation of processes, such as enterprise-level business processes, by automation systems can produce automation programs based on user requests so that the development of automation programs can be accelerated through automation and thus users need not spend so much time and effort on producing such automation programs.

In some implementations, the systems and methods described herein can be used with process automation platforms that include robotic process automation (RPA) capabilities. Generally speaking, RPA systems use computer software to emulate and integrate the actions of a user or person interacting within digital systems. In an enterprise environment, the automation systems are often designed to execute business processes, and most notably to handle high-volume, repeatable tasks that previously required humans to perform. In some cases, the automation systems use artificial intelligence (AI) and/or other machine learning technologies in various aspects of automation in addition to features for producing automation programs. The automation systems can also provide for creation, configuration, management, execution, and/or monitoring of software automation processes.

A software automation program is sometimes referred to as a software robot, software agent, or a bot. Software automation programs can accurately and repeatably perform a task or workflow they are tasked with. As one example, a software automation program can locate and read data in a document, email, file, or window. As another example, a software automation process can connect with one or more Enterprise Resource Planning (ERP), Customer Relations Management (CRM), core banking, and other business systems to distribute data where it needs to be in whatever format is necessary. As another example, a software automation program can perform data tasks, such as reformatting, extracting, balancing, error checking, moving, copying, or any other desired tasks. As another example, a software automation program can grab data desired from a webpage, application, screen, file, or other data source. As still another example, a software automation program can be triggered based on time or an event, and can serve to take files or data sets and move them to another location, whether it is to a customer, vendor, application, department or storage. These various capabilities can also be used in any combination.

Embodiments of various aspects of the invention are discussed below with reference to the accompanying figures. However, those skilled in the art will readily appreciate that the detailed description given herein with respect to these figures is for explanatory purposes as the invention extends beyond these limited embodiments.

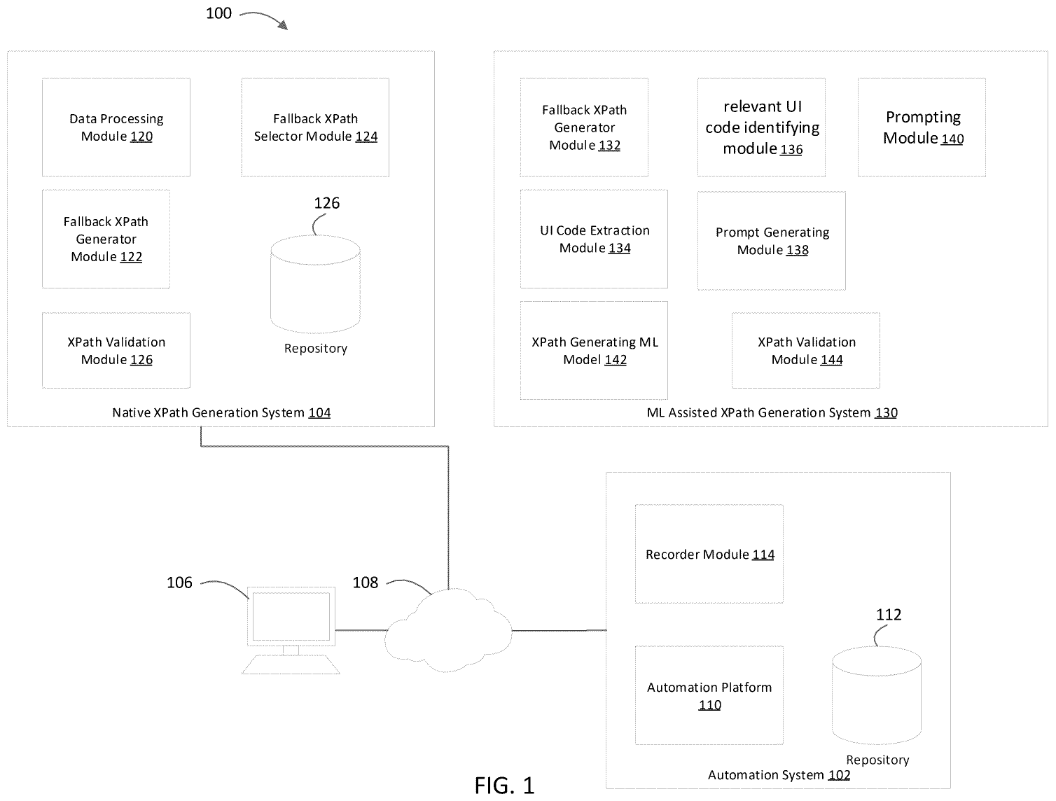

FIG. 1 is a block diagram of an automation environment 100 according to one embodiment. The automation environment 100 is a computing environment that supports the automation of processes.

The automation environment 100 includes systems, devices, and services that include an automation system 102, a client device 106 that allows a user to interact with the automation system 102, a native XPath Generation system 104, and an ML assisted XPath generation system 130, each of which are interconnected through a network 108 such as the internet, local area networks, wide area networks, and private or public clouds. In other implementations, client device 106 could be locally connected. It should also be understood that multiple client devices 106 could be connected to the various components of the automation environment 100. The client device 106 (or multiple client devices) can, for example, be an electronic device having computing capabilities, such as a mobile phone (e.g., smart phone), tablet computer, desktop computer, portable computer, server computer, and the like.

The automation system 102 includes an automation platform 110 and a repository 112. The automation platform 110 provides process automation functionality for automating processes by providing components for creating, editing, executing, and managing automation programs. In some instances, these automation programs may also be referred to as “software robots,” “bots” or “software bots.”

For example, these automation programs can interact with one or more software applications that a user uses to perform a business task. These software applications can vary widely with a user's computer system (e.g., client device 106) and specific tasks to be performed thereon. For example, the software applications that can be used include word processing programs, spreadsheet programs, email programs, ERP programs, CRM programs, web browser programs, and many more. Automation programs can interact with the software applications through graphical user interfaces or Application Programming Interfaces (APIs) of the software applications. The repository 112 can store software automation programs, including those created by the users of the automation system 102 or by other parties, and various files needed by or related to various features provided by the automation system 102. The automation system 102 can be accessed and utilized by a user using a client device 104 that is connected through the network 108.

The native XPath generation system 104 can include a data processing module 120, a fallback XPath generator module 122, a fallback XPath selector module 124, a repository 126, and an XPath validation module 126. The ML assisted XPath generation system 130 can include a fallback XPath generator module 132, a user interface (UI) code extraction module 134, a relevant UI code identifying module 136, a prompt generating module 138, a prompting module 140, an XPath generating machine learning (ML) model 142, and an XPath validation module 144.

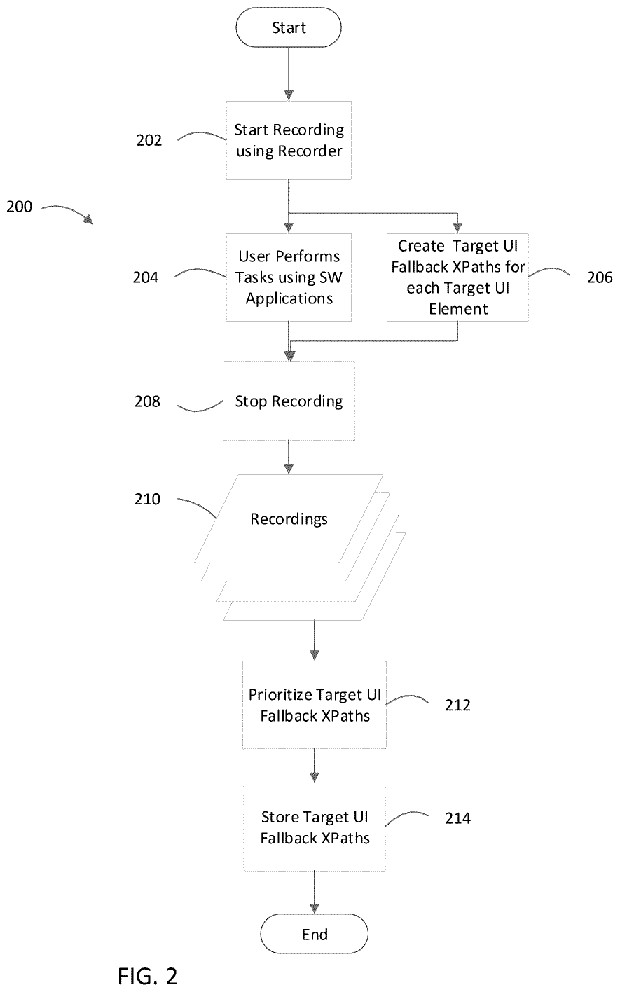

FIG. 2—Design Time, Creating the Fallback XPaths. FIG. 2 illustrates a process 200 for recording actions performed by users as they use one or more software applications to complete tasks, such as personal or business related tasks, according to one embodiment. The resulting recordings include each of the actions performed by the user and details regarding each of the actions. For example, if a user drafts an email, then a recorder module (e.g., recorder module 114) may record that the user right clicked on a user interface control of a button called “compose” and corresponding HTML button object properties of the compose button, and then record that the user pressed various alphabetical keyboard keys in order to type out a message. It should be understood that the preceding example provides a few recorded action details and that additional action details may be recorded. These recordings can then be used by the automation system 102 as the basis for forming automation programs that can be used to automate such tasks.

The process 200 starts at block 202 when a recorder (e.g., the recorder module 114) starts recording actions performed by a user, which can eventually be saved to the repository 112. At block 204, a user starts performing actions on one or more software applications in order to complete one or more tasks. At the same time the user is inducing actions, in block 206, the fallback XPath generator module 122 can identify each instance when a user interacts with a user interface element, e.g., when the user selects a user interface control element or enters information into an input field. Each user interface element that the user interacts with can be referred to as a captured UI element, as it is the UI element that the user intends to interact with. For each captured UI element, the fallback XPath generator module 112 generates one or more fallback XPaths related to the user interface control element. Each of the fallback XPaths can then be stored in the repository 126 of the native UI element XPath generation system 104. When the user completes the one or more tasks, then the recorder stops recording at block 208.

At design time of automation programs, UI parameters of the target UI control can be stored. The UI parameters can be used as validation criteria later, such as, to determine if the candidate XPaths are likely to accurately identify a target UI element.

In block 206, the process 200 generates fallback UI element XPaths for those the captured UI element that fall within multiple categories. Fallback UI element XPaths refer to XPaths that an automation platform can use in an attempt to locate a target UI element that an automation program intends to interact with in order to carry out an action that is part of a workflow for processing a task. Fallback UI element XPaths are utilized when an automation program fails to identify a target UI element during playback using conventional identification techniques, such as identifying a target UI element by identifying a UI element during playback that has the same or similar UI element parameters as such parameters of a captured UI element during the automation program's design phase. Fallback UI element XPaths are created based on criteria based on the objective of locating the target UI element, although they may or may not successfully identify the actual target UI element. Fallback UI element XPaths can also be referred to as candidate target UI element XPaths as such XPaths are XPath candidates that the automation platform can utilize in an attempt to locate target UI elements with the knowledge that each candidate UI element XPath may or may not actually identify the target UI element.

A first category of fallback (or candidate target UI) XPath is referred to as the preceding element fallback XPath category, which is based on an element that has a likelihood of preceding a target UI element. A preceding element refers to a UI element (such as an HTML element) preceding the target UI element. A preceding element can be the immediately preceding element or an element that appears somewhere earlier in the HTML code.

In one scenario, when the HTML element type that precedes the UI field that is the target of an automation step is a Label, then this process 200 can generate a label-based XPath. As is generally known, an XPath is a path expression that points to a node in an HTML document. For example, a label-based XPath could be:
//Label[texto=‘FirstName’]/following::input

This XPath points to a Label element (which can be an HTML element) that has text content of “FirstName”, and it states that the following input field should be the UI control element of interest (i.e., target UI element) for automation. In other words, this XPath expression will find all input elements that come after a Label element with the text content “FirstName”.

In this scenario, if playback of an automation process fails on this target UI element (e.g., input field HTML element), then this fallback XPath suggests that the input field following a label called “FirstName” should be the UI element that the automation process should utilize. There is a reasonable possibility of this being true since the input field followed the “FirstName” label in the UI at design time. The playback failed because the HTML parameters of the input field have changed since design time, e.g., the HTML properties of the input field changed, the position of the input field changed, etc.

In another scenario, when the HTML element that precedes the UI field that is to be captured is a Span, then this process 200 can generate a span-based XPath. For example, such an XPath could be:
//Span[text( )=‘FirstName’]/following::input

This XPath points to a Span element (which can be an HTML element) that has text content of “FirstName”, and it states that the following input field should be the UI control element of interest (i.e., target UI element) for automation. In other words, this XPath expression will find all input elements that come after a Span element with the text content “FirstName”.

In alternative implementations, the HTML element type that precedes the UI field that is the target of an automation step can be any visible text, which may be present within various HTML element types, such as but not limited to division tags (div) and table data cells (td).

Another category of candidate XPaths includes fallback XPaths of a captured UI element based on parent element attributes of the design time target UI element, e.g., the attributes such as ID, Class, Name, etc. For example, when the target UI element is an input field that has a Divisional (div) element with a certain name attribute, then the fallback UI element XPath is indicated to be an input field following a parent or a sibling UI element that also is of a div element type that has the same name attribute, such as:
//DIV[@name=‘${clickedItemName}’]/following::input
   Div HTML tags define sections of HTML documents. This XPath points to a div element (which may be an HTML element) where the name attribute equals the value of the variable ${clickedItemName}.

In another example, when the parent HTML element of the target UI element has an ID attribute of “username”, then the fallback XPath could be:
//*[@id=“username” ]
   In another example, when the parent HTML element of the target UI element is a Label element where the text content equals “Username”, then the fallback XPath generated could be:
//Label[texto=‘Username’]
   Another category of fallback UI element XPaths is a preceding sibling-based XPath, which is based on a sibling HTML element of the target UI element that precedes the captured UI element. Sibling HTML elements have the same parent HTML element. In one implementation, the fallback XPath generator module 122 identifies the sibling HTML element that precedes the target UI element, then generates the fallback preceding sibling-based XPath, such as:
//Label[texto=‘FirstName’]/following-sibling::input[1]
   Using this XPath, the XPath selector module 124 would select this fallback XPath, which would direct to a label HTML element where the text content equals “FirstName”, then the system would look to the input field of the following sibling element. The input field of the following sibling element has a likelihood of being the target input field of interest. Note that since HTML elements may have more than one sibling element, the fallback XPath generator module 122 may generate more than one fallback preceding sibling-based XPath.

Another category of fallback target UI XPath is an attribute-based XPath, which is based on the attributes of the captured UI element at design time.

In one implementation, the fallback XPath generator module 122 identifies the attributes of the target UI element, then generates the attribute-based XPath based on the attribute names and values, such as:
//input[@class=‘form-control ui-autocomplete-input’]
   Using this XPath, the XPath selector module 124 would select this fallback XPath, which would direct to an input element that has a class attribute equal to “form-control ui-autocomplete-input”. Such an input field has a likelihood of being the target input field of interest.

The fallback XPath element attributes that are required to match those of the captured UI element from design time can vary depending on desired fallback XPath identification factors. One or more of the element attributes can be required to match in order to qualify as a fallback XPath under this category.

Another category of fallback target UI XPath is a top-most parent relative position-based XPath, which is based on the position of the target UI element relative to its top-most parent element, at design time. In one implementation, the fallback XPath generator module 122 identifies the top-most parent of the target UI element, then generates the fallback XPath that points to the target UI element relative to the top-most parent element, such as:
//html[1]/body[1]/div[1]/div[1]/div[1]/div[2]/
   Using this XPath, the XPath selector module 124 would select this fallback XPath, which would direct to an element that follows from the top-most parent element. In this case, the top-most parent element can be the HTML element: to the first body element within the html element, to the first div element within the body element, to the first div element within the previous div element, to the first div element within the previous div element, to the first div element within the previous div element, or to the second div element within previous div element. This last div element has a likelihood of being the target input field of interest.

Yet another category of fallback XPath is a Cascading Style Sheet (CSS) based XPath, which is based style of the target UI element, at design time. For example, style parameters can include but are not limited to font, font size, color, and text alignment.

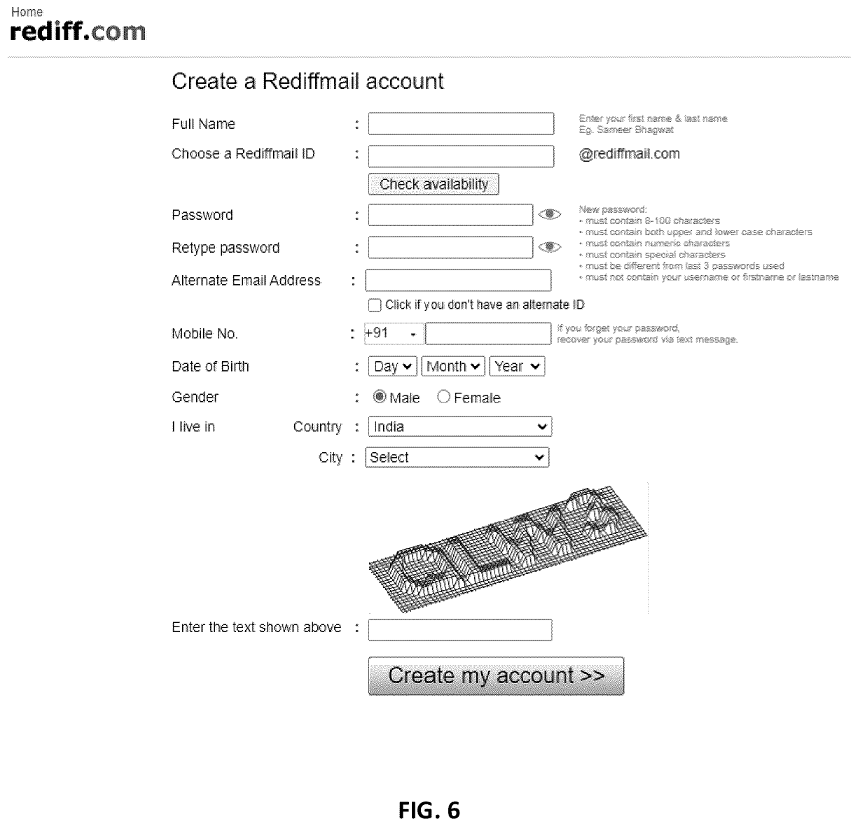

In one implementation, the fallback XPath generator module 122 identifies one or more of the style parameters of the target UI element, then generates the fallback XPath that points to the target UI element, such as:
table #tblcrtac>tbody>tr:nth-of-type(3)>td:nth-of-type(3)>input
   This exemplary XPath is the CSS path for Rediff ‘Full name’ input field, in FIG. 6. FIG. 6 is a screen shot of an exemplary user interface associated with a webpage. The webpage is, for example, for a webpage at rediff.com.

CSS is a style sheet language used for specifying the presentation and styling of a document written in a markup language, such as HTML or XML. CSS describes how HTML elements are to be displayed on screen, paper, or in other media.

A single CSS selector is selected as the fallback XPath, but in other implementations, more than one CSS selector may be selected.

In block 208, the recorder module 114 stops recording. In many instances, the recording stops after the user finishes performing actions to complete tasks. At this point, the recorder module 114 has generated one or more recordings 210.

In block 212, the generated fallback XPaths are prioritized such that the fallback XPaths can be selected for potential use in an automation process based upon its assigned priority value. In some implementations, the fallback XPaths are prioritized based on its category of fallback XPaths. For example, in order of descending priority with the highest priority of fallback XPaths listed on top, the category priorities can be: preceding element based XPath, preceding sibling based XPath, attribute based XPath, position based XPath, and the CSS based XPath.

In block 214, the fallback XPaths are stored to the repository 114 for later retrieval during playback of automation programs. After the fallback XPaths are stored, the process 200 can end.

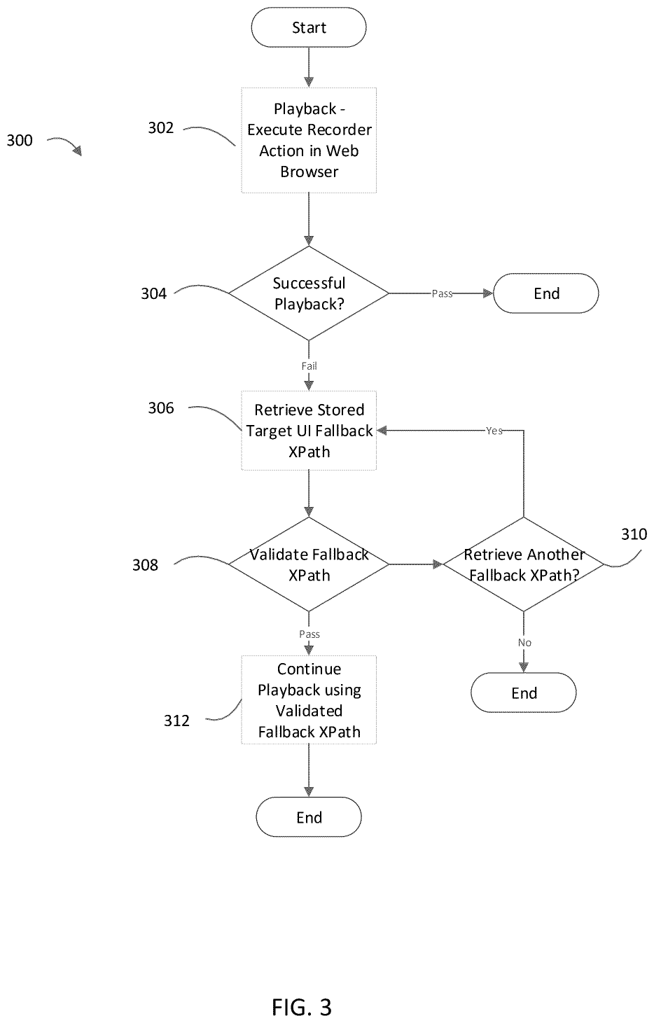

FIG. 3—Playback with Native Fallback System. FIG. 3 illustrates a process flow for playback of an automation program where a recorder is configured to utilize native fallbacks, such as via the native fallback XPath generation system 104, for situations where automation playback fails due to an inability to locate a target UI element based on the recorded UI element parameters from design time, according to one embodiment. Generally, when a target UI element cannot be identified, then one of the fallback XPaths is selected, in priority order, and validated.

After designing an automation program, in block 302, a user can decide to use the automation program to programmatically perform tasks rather than performing the actions manually him or herself. When the automation program accesses particular user interface screens of one or more software applications that are part of a workflow, the user interface screens may have changed. For example, the layout of a user interface may now have UI control elements in different locations, or dynamic attributes of the user interface may have changed.

In decision block 304, an automation playback failure can be identified, such as when the recorder module 114 is unable to identify a target UI element that an automation program needs to interact with in order to perform an automation action. If, at decision block 304, there is no playback failure when executing the automation program, then the process 300 can end normally with successful completion of the automation program. On the other hand, if a playback failure is detected at decision block 304, then block 306 can retrieve a selected fallback path, such as a previously stored target UI fallback XPath.

Validate Successful XPath Candidate. In decision block 308, validation module verifies that the selected fallback XPath points to a UI element, or HTML object, within the UI of the software application within which an automation step is to take place. If the selected fallback XPath points to a UI element, then a validation module identifies the parameters of the UI element, or HTML object, and compares such parameters against the HTML object parameters of the target UI element from design time. If the parameters of the UI element corresponding to the fallback XPath match that of the design time UI element, then the validation module decides that the fallback XPath is valid. In such case, the playback can continue 312 using the validated fallback XPath, as the target UI element for automating the automation step that had failed. If one or more of the HTML object properties do not match, then the validation module can provide a failure message indicating that the fallback XPath does not point to an HTML object that is likely to be the object that should be subject of the automation step.

When a retrieved fallback XPath fails to be validated, then the process 300 determines 310 if there is another fallback XPath to select. If so, then next fallback XPath is selected at block 310 for validation and the validation process 306 described above is repeated for this next fallback XPath. In other words, if the UI control corresponding to the successful XPath matches that of the target UI control from design time, then in block 312, the successfully validated fallback XPath is used to complete the playback of the automation program. Then the process 300 continues through to completion or until the next automation failure, which could then initiate the native fallback XPath process for another UI element that was not able to be located.

In some implementations, the validation module can decide that the fallback XPath is valid if all of the parameters match that of the design time UI element. In other implementations, the validation module can determine the fallback XPath is valid when a certain number of the parameters out of the total parameters match the design time HTML parameters. In some implementations, the validation module determines a valid fallback XPath is identified when 75% of all the parameters are matching. In other implementations, a higher or lower percentage can be selected to determine valid fallback XPaths. In other implementations, a valid fallback XPath can be determined when certain parameters match, e.g., certain more important parameters.

When there is no next fallback XPath to select, then the process 300 will not successfully complete because the target UI element for automation is not able to be found. Then process 300 then ends and a message may be sent to inform the user of the unsuccessful automation process.

HTML object properties of the UI elements can include: HTML ID, className, textContext, HTML tag, DOMXPath, HTML type, Path, HTML name, and other parameters that are well understood in the web development field.

Another embodiment concerns a ML assisted XPath generation system and process. During the recording and automation design, user actions can be recorded and saved into the repository 112 of the automation system 102.

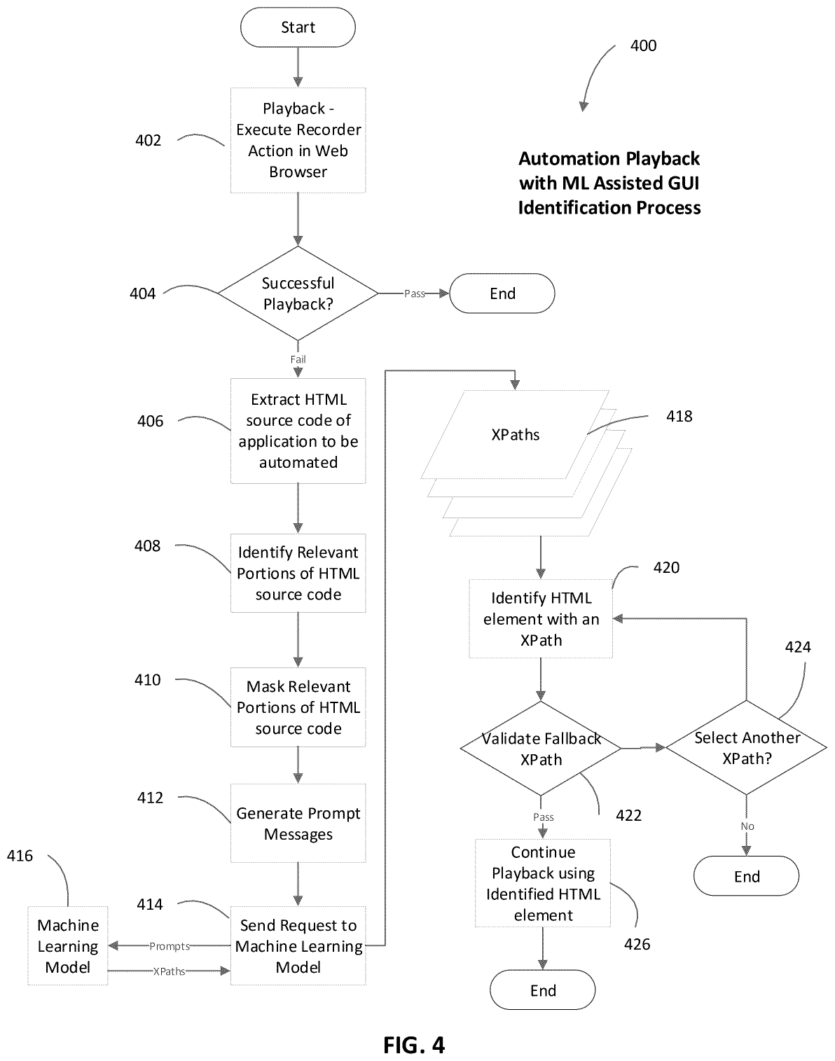

FIG. 4 illustrates a flow diagram of an automation playback process 400 that uses an ML assisted target UI identification process, according to one embodiment. After designing an automation program, in block 402, a user can decide to use the automation program to programmatically perform tasks rather than performing the actions manually him or herself. When the automation program accesses particular user interface screens of one or more software applications that are part of a workflow, the user interface screens may have changed. For example, the layout of a user interface may now have UI control elements in different locations, or dynamic attributes of the user interface may have changed.

In block 404, an automation playback failure can be identified when the recorder module 114 is unable to identify a target UI element that an automation program needs to interact with in order to perform an automation action.

In block 406, HTML source code can be extracted. For example, a browser extension can extract HTML page source code of a business application user interface on the playback device. In some instances, then entire HTML source code of the user interface is extracted. The extracted page source can be loaded into a document format for easy traversal through each element.

Techniques for finding relevant portions of HTML source code, sometimes referred to as the process of sanitizing, is represented in block 408. In block 408, the portions of the HTML source code that are relevant, or likely to contain the target UI element, are identified. The portions of the HTML source code to be identified as relevant portions can be in one or more of the following categories: 1) all input fields (or other element types that match the target UI element from design time) that follow a specific preceding text of the captured HTML object from design time; 2) all parents and/or siblings of the design time “captured” UI element; and 3) any HTML elements that have a certain number of matching attributes.

As will be described below, these relevant portions of HTML source code will be included in prompts to a ML model so that the model can compare HTML code of the captured UI element from design time against these one or more relevant portions of HTML source code. Through the comparison, a successful result will be the determination that one of the relevant portions represents the target UI element during playback of an automation program.

In one example, the relevant portion of the extracted HTML source code can include all input fields that follow a specific text value that precedes the input fields. So for example, in FIG. 6, when the certain preceding text is “Full Name”, then the HTML code for seven input fields would be identified as being relevant portions of code since there are seven text input fields that follow “Full Name”.

In another example, the relevant portion of HTML source can include the code portions that correspond to parent and child HTML objects of the captured UI element from design time. In other words, during playback, each of the parent and child HTML elements identified during design time are searched for and identified, assuming they also appear in a software application's user interface at playback time. For example, a UI element that has both matching preceding text and tag values is sought. Once this element is located, the source of the parent element, including any child elements, can be extracted. In other words, HTML code is extracted when an element having matching preceding text and tag values is found.

As another example, from an entire HTML page source, the parent element for the target element having matching preceding text and tag value can be extracted. For example, an entire table row (From <tr> to </tr>) can be extracted from the following source:

```
          <html><body>
          ...
          <tr>
                      <td width=“180”>Full Name</td>
                      <td width=“14”><b>:</b></td>
                      <td width=“200”><input type=“text” onblur=“fieldTrack(this);”
name=“namea424579f” value=”” style=“width:185px;” maxlength=“61”></td>
                      <td width=“6”></td>
                      <td width=“250”><font class=“f10” color=“#868686”>Enter
your first name &amp; last name<br>Eg. Sameer Bhagwat</font></td>
          </tr>
          ...
          </body></html>
```

In another example, HTML source code from the UI of the application during execution of the automation process can be extracted for those elements that have a certain threshold of HTML element properties that match that of the target UI element from the recording. In some implementations, when 80% of the properties of an HTML element within the UI of the software application being automated match the properties of the target HTML UI element from design time, then the HTML source code for the matching HTML element is extracted from the HTML page source code.

In block 410, masking, or anonymization, techniques are applied to the extracted HTML page source and element data, also termed data masking. The masking serves to anonymize traces of potentially sensitive business data which may be present in the source code. In some instances, masking serves anonymize sensitive data that is deep inside the source code structure.

As part of the masking process, text labels may be tokenized for additional privacy and security reasons, i.e., HTML elements may be replaced with numbers; the numbers are then mapped to values in a map. At a later time, the tokens can be replaced with the original data, e.g., text labels.

The following is an example of HTML Source extracted corresponding to a UI element that was captured when a user performed an action as part of a workflow.

<tr> <td width=“180”>Full Name</td> <td width=“14”><b>:</b></td> <td
width=“200”><input type=“text” onblur=“fieldTrack(this);” name=“named5f4fe5a”
value=”” style=“width:185px;” maxlength=“61”></td> <td width=“6”></td> <td
width=“250”><font class=“f10” color=“#868686”>Enter your first name &amp; last
name Eg. Sameer Bhagwat</font></td></tr>

Below is an example of a masked version of the above extracted HTML source.

<html><body> 1 <b>6</b><input type=“2”
onblur=“3” name=“7” style=“8”
maxlength=“5”><font class=“9”
color=“10”>11</font></body></html>

In block 412, prompt messages are created so that they can be provided to a machine learning model so that it can generate one or more XPaths where the objective is for at least one of the generated XPaths to identify the UI HTML element that an automation program needs to interact with in order to perform an automation step. In other words, the objective is for the machine learning model to generate an XPath that identifies the target UI element. At a high level, the prompts include instructions to compare relevant portions of a software application's source code during playback, which may be referred to as the relevant page source, to the captured HTML code of the UI element that a user interacts with during design time, in order to filter the relevant portions for one or more HTML elements that have higher likelihoods of being the target UI element.

The prompts include two components, system messages and user messages. The system messages provide the machine learning model with high-level instructions and examples of outputs it should provide based on certain situations and inputs. Then the user messages provide specific instructions for the ML model to follow in order to identify and generate XPaths for the UI elements that have higher likelihoods of being the target UI element.

System messages or instructions contain the high-level, or contextual instructions for LLM models, including role definition instructions that allow LLM model responses to be provided from a specific perspective, e.g., you are a smart automation platform assistant. The role definition instructions may also instruct the ML model to take on a certain personality trait. System messages also contain examples of outputs it should provide based on certain situations and inputs. In some implementations, system messages also contain contextual instructions, such as domain knowledge specific to a certain applications so that the LLM will be able to have the specific knowledge needed to provide relevant outputs. These high-level instructions may also define what a model should and should not provide as outputs, and can define the format of model outputs or responses. These instructions can be provided as prompts into the machine learning models and can be thought of as a way of dynamically training the models. Other techniques for prompting machine learning models include few-shot learning and chain of thought.

To summarize, the system prompts can include the following components:
1. Role definition instruction
2. One or more examples of outputs it should provide based on certain criteria and inputs.

In one implementation, the role definition prompt could be as follows:
You are an assistant designed to find and return XPaths of matching elements from HTML source.

In one implementation, providing an example of desired ML model output in response to certain input and criteria can be provided in the below format:
Description of a certain scenario.
Relevant page source code that could be identified from a software application's user interface that is subject to an automation program.
Input or the HTML code of UI element that was interacted with by a user during a workflow during the design time of the automation.
Desired output and format of the output for the scenario.

Scenarios may, for example, include those where a few attributes of the relevant page source code match those of the input, those where only one attribute matches, those where two attributes match, those where no attributes match, and those where a certain preceding text is not found.

User messages can contain instructions to a machine learning model as to the steps it is requested to perform. User messages include input needed by the machine learning model to produce one or more outputs, for example input from an automation process where a target UI element cannot be found. One example of a high-level user message is:
Get all matching elements from HTML source <html><body><input id=“firstname”/></body></html>

Below is another exemplary implementation of a user message. The objective is to filter for HTML objects within the relevant page source portions that are more likely to be the target UI element that the automation program is attempting to interact with. These instructions guide the process of identifying a target UI element of a text input field preceded by certain preceding text, where the target UI element corresponds to the UI element captured during automation program design time, which is the UI element that a user interacted with during a particular step in a workflow.
“RELEVANT HTML SOURCE: <html><body>1<b>6</b><input type=\“2\” onblur=\“3\” name=\“7\” style=\“8\” maxlength=\“5\”><font class=\“9\” color=\“10\”>11</font></body></html>
Step 1: Get all HTML ELEMENTS from HTML SOURCE with TAG ‘input’ and PRECEDING TEXT ‘1’. Ensure that all MATCHING ELEMENTS should be after PRECEDING TEXT
Step 2.1: Filter all MATCHING ELEMENTS from Step 1 with attributes [type=\“2\” and onblur=\“<html><body>3</body></html>\” and
name=\“<html><body>4</body></html>\” and
maxlength=\“<html><body>5</body></html>\” ]
Step 2.2: If no MATCHING ELEMENT found in Step 2.1, then Filter all MATCHING ELEMENTS from Step 1 with minimum one matching attribute and preferred multiple matching attributes from
[type=\“<html><body>2</body></html>\” or
onblur=\“<html><body>3</body></html>\” or
name=\“<html><body>4</body></html>\” or
maxlength=\“<html><body>5</body></html>\”]
Step 2.3: If no MATCHING ELEMENT found in Step 2.2, then get the first MATCHING ELEMENT from Step 1
Step 3: If MATCHING ELEMENT found after Steps 1 & 2, Return XPaths containing actual attributes of the MATCHING ELEMENT only from HTML SOURCE in JSON format. Otherwise return { }.

As shown in the user instructions above, the INPUT represents that captured UI element from design time.

The RELEVANT HTML SOURCE presents the relevant page source portions from the HTML source code of a software application user interface that is subject to an automation program. This source is, for example, the relevant portions of HTML source code, such as identified in block 408 of FIG. 4.

This relevant HTML source includes the preceding text element AND the following input field.

Instruction step 1: get all HTML elements from the relevant page source portions that have a same HTML tag type and preceding text as that of the input HTML (the HTML captured at design time). For instance, the specific HTML tag could be an input tag since the captured UI element from design time was an input field following a preceding text of “Full Name”. In this instance, the user during design time interacted with the input field by entering text, likely the user's full name, into an input field having preceding text of “Full Name”. The retrieved HTML elements that satisfy these criteria may be referred to as MATCHING ELEMENTS.

Instruction step 2.1: Given the identified HTML elements from step 1, filter for those that have a certain number of attributes in common with the input HTML code. In other words, this instruction step lists a desired number of the attributes from the input HTML code. In some instances, the number of attributes in common may be 2, 3, or 4, but it could be more depending on design goals.

Instruction step 2.2: If no HTML elements were identified by the filtering in step 2.1, then filter for those HTML elements with at least one attribute in common out of a set of a certain number of possible attributes. For example, filter for an HTML element where at least one of a HTML body type, onblur type, body name, class, or body maximum length attribute are in common. Also, in some instances, this instruction can state a priority of the attribute types where the higher priority attribute types are given more weight in identifying elements with matching attributes. For example, if the attributes are id, name, class, and maxlength, then id, name, and maxlength should be given higher priority than class. For example, when the two following elements are found: 1) one element with only the class attribute matching with the input, and 2) an element that has only name attribute matching, then priority is given to the second element where name attribute matches.

Instruction step 2.3: In no matching HTML elements were identified in step 2.2, then select the first element in step 1 following the certain preceding text that has the same HTML tag.

Instruction step 3: If matching HTML elements are found after any of the above steps, then generate XPaths using the attributes from the page source code, and create the XPaths in JSON format. Alternatively, if no matching HTML elements were found, then return a null set output to indicate to the user or automation platform that no matching HTML elements can be identified.

In some implementations, if input attribute values differ from corresponding ones in MATCHING ELEMENT from HTML SOURCE, then the instructions may state that only corresponding attribute values from MATCHING ELEMENT in HTML SOURCE should be used as attribute values in XPaths. Also, if an XPath contains attributes which are not in MATCHING ELEMENT, then remove such attributes from the XPath.

In block 414, a prompting module sends the generated prompt messages to a machine learning model 416, such as a Large Language Model (LLM). In some instances, the LLM can be provided as a service via a cloud software services provider. The machine learning model 416 generates and returns XPaths for the matching HTML elements found in block 410. The generated XPaths can be contained in XPath JSON files 418.

In block 420, the JSON files are processed to arrive at XPaths that can be used by the automation platform to identify the target UI element. For instance, the JSONs can be converted to a list of XPaths and returned to the automation platform via an API. The XPaths can then be put through a reverse masking process to replace tokens with the actual data that was previously masked. Then, the process 400 continues by generating different XPath combinations by removing dynamic attributes from the list of XPaths. Then, the resulting XPaths can be used to identify the UI elements.

In decision block 422, a validation process can be performed to validate that the identified UI elements are likely to be the target UI element. In some implementations, the HTML properties of the identified HTML element and nearby elements are compared against the captured HTML element properties, and nearby elements, from design time. The identified UI element with matching properties, or the most matching properties, is then considered to be a valid target UI element and can be used to continue the automation process from the point where it had failed to identify the target UI element previously.

In block 426, the process 400 can continue playback using the newly identified target UI element that has been validated.

In block 424, if no identified HTML element is validated, then the process 400 can end. In some instances, a message is sent to the user indicating that automation has failed due to the inability to identify a target UI element. Alternatively, the process 400 can select another yet unselected XPath from the list of generated XPaths contained in the XPath JSON files 418 and then proceed to the validation process 422 once again. Alternatively, once there are no other unselected XPaths to be processed, the process 400 can end.

In some implementations, the order of the instructions affects the effectiveness of identifying HTML elements out of the relevant portions that will represent the target UI element.

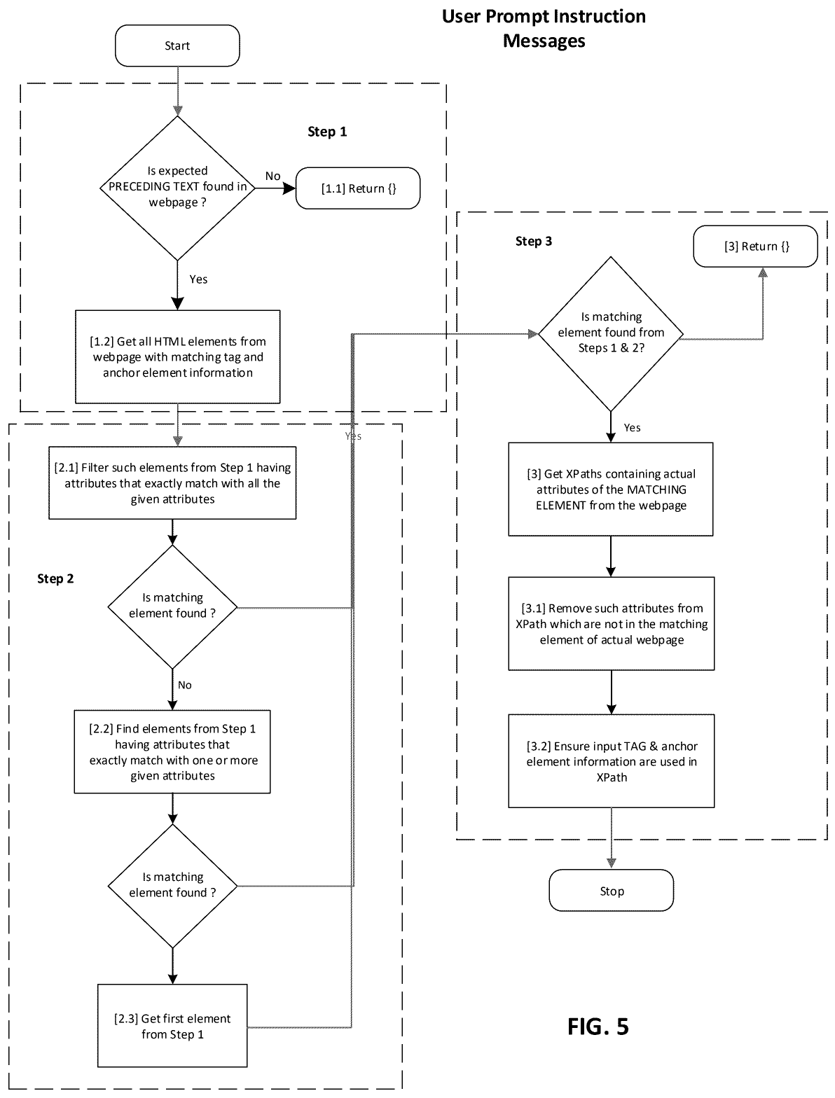

FIG. 5 is a flow diagram that illustrates operations of user instructions for an ML model for identifying HTML elements of a software application during playback of an automation program, according to one embodiment.

As part of the playback process using the ML assisted UI element identification process, the identified relevant HTML code can, for example, be:
RELEVANT HTML SOURCE: <html><body><div class=“1”><div class=“2”><span class=“pristine”>Build</span></div><help><span class=“14”>Help Build</span></help><div class=“16”><slot name=“18”><formatted type=“field” slot=“output” class=“valid”>Workspace</formatted><br/><formatted type=“textbox” slot=“output” class=“valid”>Automation</formatted></slot></div></div></body></html>

And the input, i.e., the HTML code of the captured UI element from design time can, for example, be:
INPUT: TAG “formatted”; PRECEDING TEXT “Build”; Attributes:
[type=“textbox”, slot=“box”, class=“pristine”, id=“Field1” ]

User message step 1 asks the ML model if the identified preceding text from design time, e.g., “Build”, is found in the user interface of the software application. In this example, it is found.

User message step 1.2 asks to get all HTML ELEMENTS from HTML SOURCE with TAG ‘formatted’ and PRECEDING TEXT ‘Build’. The result includes the two HTML elements of:
<formatted type=“field” slot=“output” class=“valid”>Workspace</formatted>; and
<formatted type=“textbox” slot=“output” class=“valid”>Automation</formatted>

User message Step 2.1 asks to filter the resulting elements from the preceding step 1.2 where all of the following attributes match: [type=“textbox”, slot=“box”, class=“pristine”, id=“Field1”]

In this example, the result is that there is no element with all matching attributes. Then, the processing would proceed to Step 2.2.ser message Step 2.2 asks to filter elements with one or more matching attributes from [type=“textbox”, slot=“box”, class=“pristine”, id=“Field1”]

In this example, the result is:
<formatted type=“textbox” slot=“output” class=“valid”>Automation</formatted>

This HTML element is one of the Step 1.2 results since it has one matching attribute, i.e., type=“textbox”

User message Step 3 asks the ML to get XPaths containing actual attributes of the MATCHING ELEMENT from the webpage.

The result: //formatted[@type=“textbox” and @slot=“output” and @class=“valid” and @id=“Field1”]

User message step 3.1 ask the ML to remove extra attributes from XPath.

The result: //formatted[@type=“textbox” and @slot=“output” and @class=“valid” ]

The user message step 3.2 asks to insure input TAG & Preceding Text information are used in XPath.

The result: (//formatted[@type=“textbox” and @slot=“output” and @class=“valid” and preceding::text( )[normalize-space( )=“Build” ]])[1]

Matching elements refers to UI elements that have a likelihood of being the target UI element that an automation program intends to interact with and which has matching desired criteria of the target UI element.

HTML SOURCE/Relevant Page Source: This is the selected “relevant portion(s)” of the application page's HTML source code, which can also be referred to as the “sanitized portions” of the HTML source code. As was described earlier, the relevant portions are also masked for security purposes. These relevant portions are likely to contain the target UI element that needs to be identified during automation playback.

Input/Captured UI Element HTML Code: This is the HTML source code of the captured UI element that a user interacted with during automation program design time as part of a workflow. Note that known dynamic HTML elements are removed from the input since, by their dynamic nature, their design time and playback time values are not likely to match. However, in some instances, dynamic elements may remain in the input since it is difficult or not possible to identify the dynamic value of certain HTML elements or properties.

The data saved at capture time in the recorder action that can be passed in the user message within ChatCompletionRequest. LLM model can process this data to find the XPath of matching element.

Output: JSON object containing XPath of matching element returned by the LLM model in ChatCompletionResponse>message>content.

Anchor elements may refer to UI elements around which target UI elements will be located. In some instances, anchor elements are preceding texts, which are the text values that appear before the target UI elements. In other implementations, anchor elements may be other nearby elements such as a following element, ancestor elements, parent elements, sibling elements, etc.

Step 3: Yes, we ask the LLM model to generate XPath of matching element. Then, we ask it to refine the XPath as per our requirement in Steps 3.1 & 3.2.

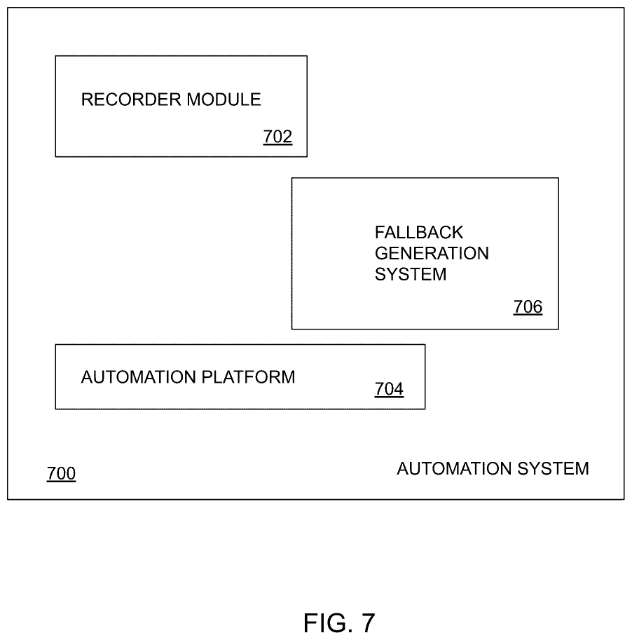

FIG. 7 is a block diagram of an automation system 700 according to one embodiment.

The automation system 700 can operate on one or more electronic device having computing capabilities. The electronic device having computing capabilities can, for example, pertain to a mobile phone (e.g., smart phone), tablet computer, desktop computer, portable computer, server computer, and the like. As one example, the automation system 700 can operate on the client device 106 illustrated in FIG. 1. As another example, the automation system 700 can operate on a server computer.

The automation system 700 can include a recorder module 702. The recorder module 702 can be used to record a user's actions while taking such actions, such as interacting with UI elements of software applications that a user is interacting with while performing actions to process a task. Each of the UI elements that a user interacts with during this time can be referred to as a UI element that the recorder module captures. The recordings saved by the recorder module 702 can be used to assist in creating an automation program that can later be used to automatically, or programmatically, perform the same or similar actions taken by the user so that the tasks, or workflows, can be effectively and efficiently completed.

The automation system 700 also includes an automation platform 704 that provides process automation functionality for automating processes by providing components for creating, editing, executing, and managing automation programs. In some instances, these automation programs may also be referred to as “software robots,” “bots” or “software bots.” For example, these automation programs can interact with one or more software applications that a user uses to perform a business task. These software applications can vary widely with a user's computer system (e.g., client device 106) and specific tasks to be performed thereon. For example, the software applications that can be used include word processing programs, spreadsheet programs, email programs, ERP programs, CRM programs, web browser programs, and many more. Automation programs can interact with the software applications through graphical user interfaces or Application Programming Interfaces (APIs) of the software applications.

Further, the automation system 700 can include a fallback generation system 706. The fallback generation system 706 can be used to generate fallback element locators that can be utilized to assist with locating UI elements that can be used when attempting to locate a target UI element that an automation program intends to interact with in order to carry out an action that is part of a workflow for processing a task. Hence, these fallback element locators are utilized when an automation program fails to identify a target UI element during playback using conventional identification techniques.

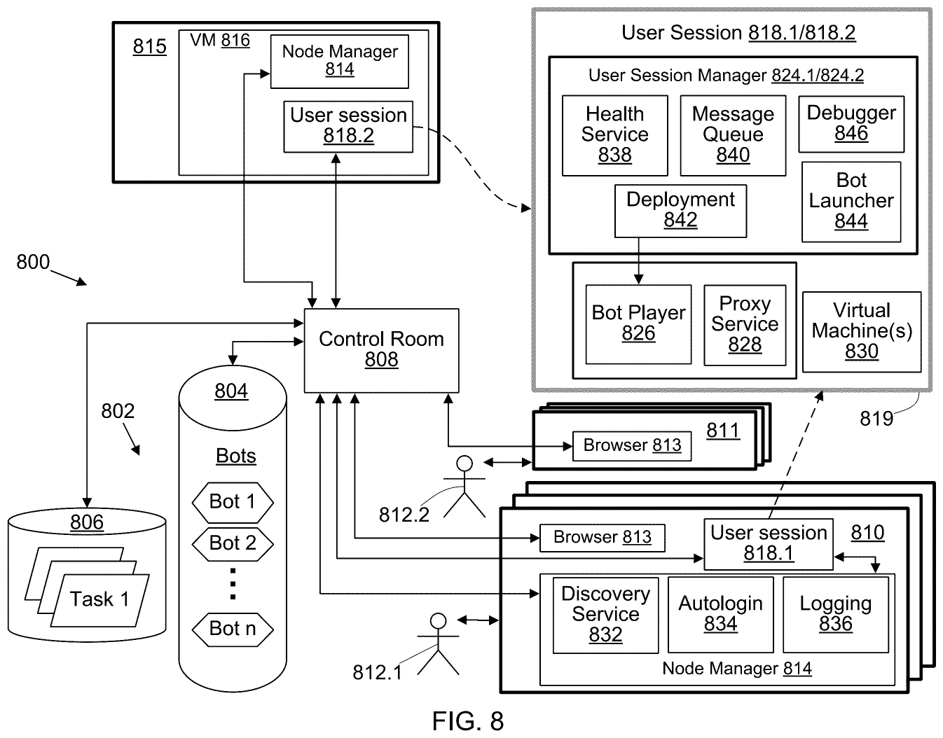

FIG. 8 is a block diagram of a robotic process automation (RPA) system 800 according to one embodiment. The RPA system 800 includes data storage 802. The data storage 802 can store a plurality of software robots 804, also referred to as bots (e.g., Bot 1, Bot 2, . . . , Bot n). The software robots 804 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 826), on which a bot will execute or is executing. The data storage 802 can also stores a plurality of work items 806. Each work item 806 can pertain to processing executed by one or more of the software robots 804.

The RPA system 800 can also include a control room 808. The control room 808 is operatively coupled to the data storage 802 and is configured to execute instructions that, when executed, cause the RPA system 800 to respond to a request from a client device 810 that is issued by a user 812.1. The control room 808 can act as a server to provide to the client device 810 the capability to perform an automation task to process a work item from the plurality of work items 806. The RPA system 800 is able to support multiple client devices 810 concurrently, each of which will have one or more corresponding user session(s) 818, which provides a context. The context can, for example, include security, permissions, audit trails, etc. to define the permissions and roles for bots operating under the user session 818. For example, a bot executing under a user session, cannot access any files or use any applications that the user, under whose credentials the bot is operating, does not have permission to do so. This prevents any inadvertent or malicious acts from a bot under which bot 804 executes.

The control room 808 can provide, to the client device 810, software code to implement a node manager 814. The node manager 814 executes on the client device 810 and provides a user 812 a visual interface via browser 813 to view progress of and to control execution of automation tasks. It should be noted that the node manager 814 can be provided to the client device 810 on demand, when required by the client device 810, to execute a desired automation task. In one embodiment, the node manager 814 may remain on the client device 810 after completion of the requested automation task to avoid the need to download it again. In another embodiment, the node manager 814 may be deleted from the client device 810 after completion of the requested automation task. The node manager 814 can also maintain a connection to the control room 808 to inform the control room 808 that device 810 is available for service by the control room 808, irrespective of whether a live user session 818 exists. When executing a bot 804, the node manager 814 can impersonate the user 812 by employing credentials associated with the user 812.

The control room 808 initiates, on the client device 810, a user session 818 (seen as a specific instantiation 818.1) to perform the automation task. The control room 808 retrieves the set of task processing instructions 804 that correspond to the work item 806. The task processing instructions 804 that correspond to the work item 806 can execute under control of the user session 818.1, on the client device 810. The node manager 814 can provide update data indicative of status of processing of the work item to the control room 808. The control room 808 can terminate the user session 818.1 upon completion of processing of the work item 806. The user session 818.1 is shown in further detail at 819, where an instance 824.1 of user session manager 824 is seen along with a bot player 826, proxy service 828, and one or more virtual machine(s) 830, such as a virtual machine that runs Java® or Python®. The user session manager 824 provides a generic user session context within which a bot 804 executes.

The bots 804 execute on a player, via a computing device, to perform the functions encoded by the bot. Some or all of the bots 804 may in certain embodiments be located remotely from the control room 808. Moreover, the devices 810 and 811, which may be conventional computing devices, such as for example, personal computers, server computers, laptops, tablets and other portable computing devices, may also be located remotely from the control room 808. The devices 810 and 811 may also take the form of virtual computing devices. The bots 804 and the work items 806 are shown in separate containers for purposes of illustration but they may be stored in separate or the same device(s), or across multiple devices. The control room 808 can perform user management functions, source control of the bots 804, along with providing a dashboard that provides analytics and results of the bots 804, performs license management of software required by the bots 804 and manages overall execution and management of scripts, clients, roles, credentials, security, etc. The major functions performed by the control room 808 can include: (i) a dashboard that provides a summary of registered/active users, tasks status, repository details, number of clients connected, number of scripts passed or failed recently, tasks that are scheduled to be executed and those that are in progress; (ii) user/role management—permits creation of different roles, such as bot creator, bot runner, admin, and custom roles, and activation, deactivation and modification of roles; (iii) repository management—to manage all scripts, tasks, workflows and reports etc.; (iv) operations management—permits checking status of tasks in progress and history of all tasks, and permits the administrator to stop/start execution of bots currently executing; (v) audit trail—logs creation of all actions performed in the control room; (vi) task scheduler—permits scheduling tasks which need to be executed on different clients at any particular time; (vii) credential management—permits password management; and (viii) security: management—permits rights management for all user roles. The control room 808 is shown generally for simplicity of explanation. Multiple instances of the control room 808 may be employed where large numbers of bots are deployed to provide for scalability of the RPA system 800.

In the event that a device, such as device 811 (e.g., operated by user 812.2) does not satisfy the minimum processing capability to run a node manager 814, the control room 808 can make use of another device, such as device 815, that has the requisite capability. In such case, a node manager 814 within a Virtual Machine (VM), seen as VM 816, can be resident on the device 815. The node manager 814 operating on the device 815 can communicate with browser 813 on device 811. This approach permits RPA system 800 to operate with devices that may have lower processing capability, such as older laptops, desktops, and portable/mobile devices such as tablets and mobile phones. In certain embodiments the browser 813 may take the form of a mobile application stored on the device 811. The control room 808 can establish a user session 818.2 for the user 812.2 while interacting with the control room 808 and the corresponding user session 818.2 operates as described above for user session 818.1 with user session manager 824 operating on device 810 as discussed above.

In certain embodiments, the user session manager 824 provides five functions. First is a health service 838 that maintains and provides a detailed logging of bot execution including monitoring memory and CPU usage by the bot and other parameters such as number of file handles employed. The bots 804 can employ the health service 838 as a resource to pass logging information to the control room 808. Execution of the bot is separately monitored by the user session manager 824 to track memory, CPU, and other system information. The second function provided by the user session manager 824 is a message queue 840 for exchange of data between bots executed within the same user session 818. The third function is a deployment service (also referred to as a deployment module) 842 that connects to the control room 808 to request execution of a requested bot 804. The deployment service 842 can also ensure that the environment is ready for bot execution, such as by making available dependent libraries. The fourth function is a bot launcher 844 which can read metadata associated with a requested bot 804 and launch an appropriate container and begin execution of the requested bot. The fifth function is a debugger service 846 that can be used to debug bot code.

The bot player 826 can execute, or play back, a sequence of instructions encoded in a bot. The sequence of instructions can, for example, be captured by way of a recorder when a human performs those actions, or alternatively the instructions are explicitly coded into the bot. These instructions enable the bot player 826, to perform the same actions as a human would do in their absence. In one implementation, the instructions can compose of a command (action) followed by set of parameters, for example: Open Browser is a command, and a URL would be the parameter for it to launch a web resource. Proxy service 828 can enable integration of external software or applications with the bot to provide specialized services. For example, an externally hosted artificial intelligence system could enable the bot to understand the meaning of a “sentence.”

The user 812.1 can interact with node manager 814 via a conventional browser 813 which employs the node manager 814 to communicate with the control room 808. When the user 812.1 logs in from the client device 810 to the control room 808 for the first time, the user 812.1 can be prompted to download and install the node manager 814 on the device 810, if one is not already present. The node manager 814 can establish a web socket connection to the user session manager 824, deployed by the control room 808 that lets the user 812.1 subsequently create, edit, and deploy the bots 804.

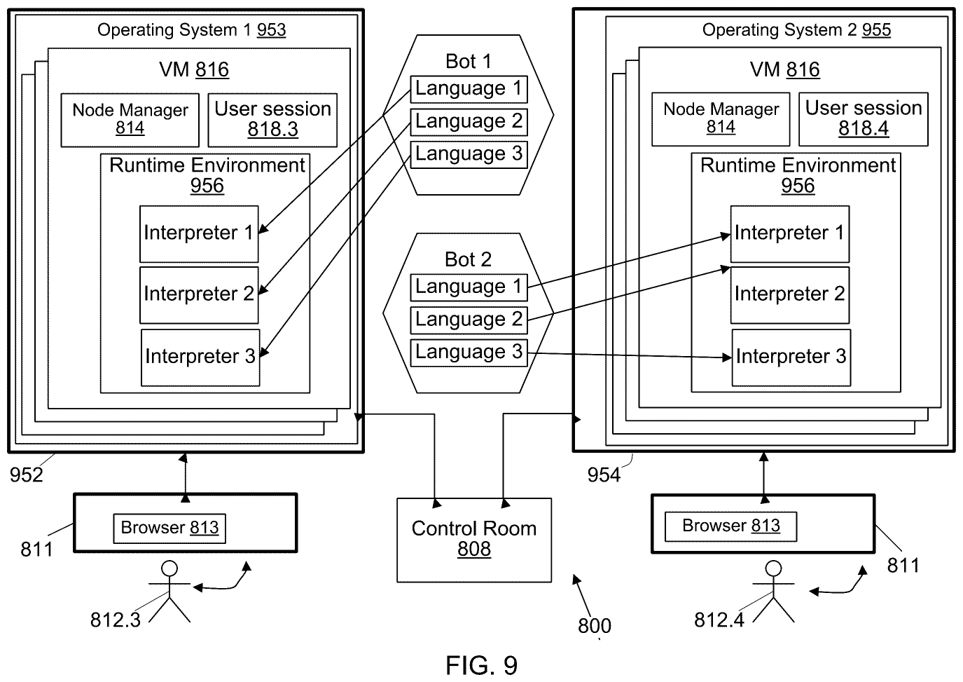

FIG. 9 is a block diagram of a generalized runtime environment for bots 804 in accordance with another embodiment of the RPA system 800 illustrated in FIG. 8. This flexible runtime environment advantageously permits extensibility of the platform to enable use of various languages in encoding bots. In the embodiment of FIG. 9, RPA system 800 generally operates in the manner described in connection with FIG. 8, except that in the embodiment of FIG. 9, some or all of the user sessions 818 execute within a virtual machine 816. This permits the bots 804 to operate on an RPA system 800 that runs on an operating system different from an operating system on which a bot 804 may have been developed. For example, if a bot 804 is developed on the Windows® operating system, the platform agnostic embodiment shown in FIG. 9 permits the bot 804 to be executed on a device 952 or 954 executing an operating system 953 or 955 different than Windows®, such as, for example, Linux. In one embodiment, the VM 816 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 9, multiple devices 952 can execute operating system 1, 953, which may, for example, be a Windows® operating system. Multiple devices 954 can execute operating system 2, 955, which may, for example, be a Linux® operating system. For simplicity of explanation, two different operating systems are shown, by way of example and additional operating systems such as the macOS®, or other operating systems may also be employed on devices 952, 954 or other devices. Each device 952, 954 has installed therein one or more VM's 816, each of which can execute its own operating system (not shown), which may be the same or different than the host operating system 953/955. Each VM 816 has installed, either in advance, or on demand from control room 808, a node manager 814. The embodiment illustrated in FIG. 9 differs from the embodiment shown in FIG. 8 in that the devices 952 and 954 have installed thereon one or more VMs 816 as described above, with each VM 816 having an operating system installed that may or may not be compatible with an operating system required by an automation task. Moreover, each VM has installed thereon a runtime environment 956, each of which has installed thereon one or more interpreters (shown as interpreter 1, interpreter 2, and interpreter 3). Three interpreters are shown by way of example but any run time environment 956 may, at any given time, have installed thereupon less than or more than three different interpreters. Each interpreter 956 is specifically encoded to interpret instructions encoded in a particular programming language. For example, interpreter 1 may be encoded to interpret software programs encoded in the Java® programming language, seen in FIG. 9 as language 1 in Bot 1 and Bot 2. Interpreter 2 may be encoded to interpret software programs encoded in the Python® programming language, seen in FIG. 9 as language 2 in Bot 1 and Bot 2, and interpreter 3 may be encoded to interpret software programs encoded in the R programming language, seen in FIG. 9 as language 3 in Bot 1 and Bot 2.

Turning to the bots Bot 1 and Bot 2, each bot may contain instructions encoded in one or more programming languages. In the example shown in FIG. 9, each bot can contain instructions in three different programming languages, for example, Java®, Python® and R. This is for purposes of explanation and the embodiment of FIG. 9 may be able to create and execute bots encoded in more or less than three programming languages. The VMs 816 and the runtime environments 956 permit execution of bots encoded in multiple languages, thereby permitting greater flexibility in encoding bots. Moreover, the VMs 816 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 808 will select a device with a VM 816 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

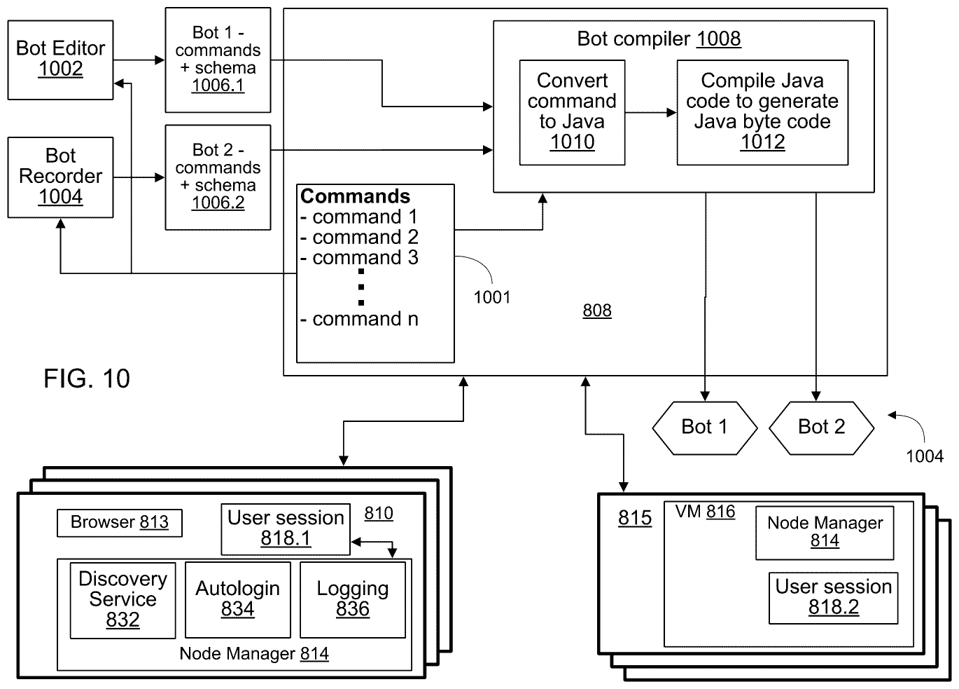

FIG. 10 illustrates a block diagram of yet another embodiment of the RPA system 800 of FIG. 8 configured to provide platform independent sets of task processing instructions for bots 804. Two bots 804, bot 1 and bot 2 are shown in FIG. 10. Each of bots 1 and 2 are formed from one or more commands 1001, each of which specifies a user level operation with a specified application program, or a user level operation provided by an operating system. Sets of commands 1006.1 and 1006.2 may be generated by bot editor 1002 and bot recorder 1004, respectively, to define sequences of application-level operations that are normally performed by a human user. The bot editor 1002 may be configured to combine sequences of commands 1001 via an editor. The bot recorder 1004 may be configured to record application-level operations performed by a user and to convert the operations performed by the user to commands 1001. The sets of commands 1006.1 and 1006.2 generated by the editor 1002 and the recorder 1004 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 808 operates to compile, via compiler 1008, the sets of commands generated by the editor 1002 or the recorder 1004 into platform independent executables, each of which is also referred to herein as a bot JAR (Java ARchive) that perform application-level operations captured by the bot editor 1002 and the bot recorder 1004. In the embodiment illustrated in FIG. 10, the set of commands 1006, representing a bot file, can be captured in a JSON (JavaScript Object Notation) format which is a lightweight data-interchange text-based format. JSON is based on a subset of the JavaScript Programming Language Standard ECMA-262 3rd Edition—December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 810 and/or 815 to perform the encoded application-level operations that are normally performed by a human user.

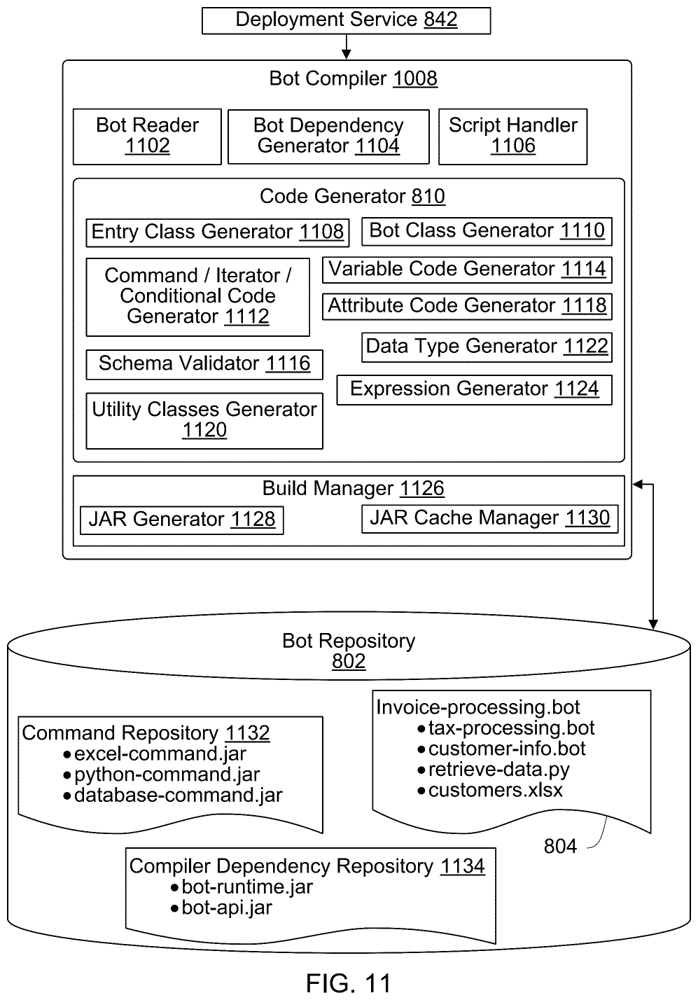

FIG. 11 is a block diagram illustrating details of one embodiment of the bot compiler 1008 illustrated in FIG. 10. The bot compiler 1008 accesses one or more of the bots 804 from the data storage 802, which can serve as bot repository, along with commands 1001 that are contained in a command repository 1132. The bot compiler 808 can also access compiler dependency repository 1134. The bot compiler 808 can operate to convert each command 1001 via code generator module 1010 to an operating system independent format, such as a Java command. The bot compiler 808 then compiles each operating system independent format command into byte code, such as Java byte code, to create a bot JAR. The convert command to Java module 1010 is shown in further detail in FIG. 11 by JAR generator 1128 of a build manager 1126. The compiling to generate Java byte code module 1012 can be provided by the JAR generator 1128. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 10, deployment service 842 can be responsible to trigger the process of bot compilation and then once a bot has compiled successfully, to execute the resulting bot JAR on selected devices 810 and/or 815. The bot compiler 1008 can comprises a number of functional modules that, when combined, generate a bot 804 in a JAR format. A bot reader 1102 loads a bot file into memory with class representation. The bot reader 1102 takes as input a bot file and generates an in-memory bot structure. A bot dependency generator 1104 identifies and creates a dependency graph for a given bot. It includes any child bot, resource file like script, and document or image used while creating a bot. The bot dependency generator 1104 takes, as input, the output of the bot reader 1102 and provides, as output, a list of direct and transitive bot dependencies. A script handler 1106 handles script execution by injecting a contract into a user script file. The script handler 1106 registers an external script in manifest and bundles the script as a resource in an output JAR. The script handler 1106 takes, as input, the output of the bot reader 1102 and provides, as output, a list of function pointers to execute different types of identified scripts like Python, Java, VB scripts.

An entry class generator 1108 can create a Java class with an entry method, to permit bot execution to be started from that point. For example, the entry class generator 1108 takes, as an input, a parent bot name, such “Invoice-processing.bot” and generates a Java class having a contract method with a predefined signature. A bot class generator 1110 can generate a bot class and orders command code in sequence of execution. The bot class generator 1110 can take, as input, an in-memory bot structure and generates, as output, a Java class in a predefined structure. A Command/Iterator/Conditional Code Generator 1112 wires up a command class with singleton object creation, manages nested command linking, iterator (loop) generation, and conditional (If/Else If/Else) construct generation. The Command/Iterator/Conditional Code Generator 1112 can take, as input, an in-memory bot structure in JSON format and generates Java code within the bot class. A variable code generator 1114 generates code for user defined variables in the bot, maps bot level data types to Java language compatible types, and assigns initial values provided by user. The variable code generator 1114 takes, as input, an in-memory bot structure and generates Java code within the bot class. A schema validator 1116 can validate user inputs based on command schema and includes syntax and semantic checks on user provided values. The schema validator 1116 can take, as input, an in-memory bot structure and generates validation errors that it detects. The attribute code generator 1118 can generate attribute code, handles the nested nature of attributes, and transforms bot value types to Java language compatible types. The attribute code generator 1118 takes, as input, an in-memory bot structure and generates Java code within the bot class. A utility classes generator 1120 can generate utility classes which are used by an entry class or bot class methods. The utility classes generator 1120 can generate, as output, Java classes. A data type generator 1122 can generate value types useful at runtime. The data type generator 1122 can generate, as output, Java classes. An expression generator 1124 can evaluate user inputs and generates compatible Java code, identifies complex variable mixed user inputs, inject variable values, and transform mathematical expressions. The expression generator 1124 can take, as input, user defined values and generates, as output, Java compatible expressions.

The JAR generator 1128 can compile Java source files, produces byte code and packs everything in a single JAR, including other child bots and file dependencies. The JAR generator 1128 can take, as input, generated Java files, resource files used during the bot creation, bot compiler dependencies, and command packages, and then can generate a JAR artifact as an output. The JAR cache manager 1130 can put a bot JAR in cache repository so that recompilation can be avoided if the bot has not been modified since the last cache entry. The JAR cache manager 1130 can take, as input, a bot JAR.

In one or more embodiment described herein command action logic can be implemented by commands 1001 available at the control room 808. This permits the execution environment on a device 810 and/or 815, such as exists in a user session 818, to be agnostic to changes in the command action logic implemented by a bot 804. In other words, the manner in which a command implemented by a bot 804 operates need not be visible to the execution environment in which a bot 804 operates. The execution environment is able to be independent of the command action logic of any commands implemented by bots 804. The result is that changes in any commands 1001 supported by the RPA system 800, or addition of new commands 1001 to the RPA system 800, do not require an update of the execution environment on devices 810, 815. This avoids what can be a time and resource intensive process in which addition of a new command 1001 or change to any command 1001 requires an update to the execution environment to each device 810, 815 employed in an RPA system. Take, for example, a bot that employs a command 1001 that logs into an on-online service. The command 1001 upon execution takes a Uniform Resource Locator (URL), opens (or selects) a browser, retrieves credentials corresponding to a user on behalf of whom the bot is logging in as, and enters the user credentials (e.g., username and password) as specified. If the command 1001 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

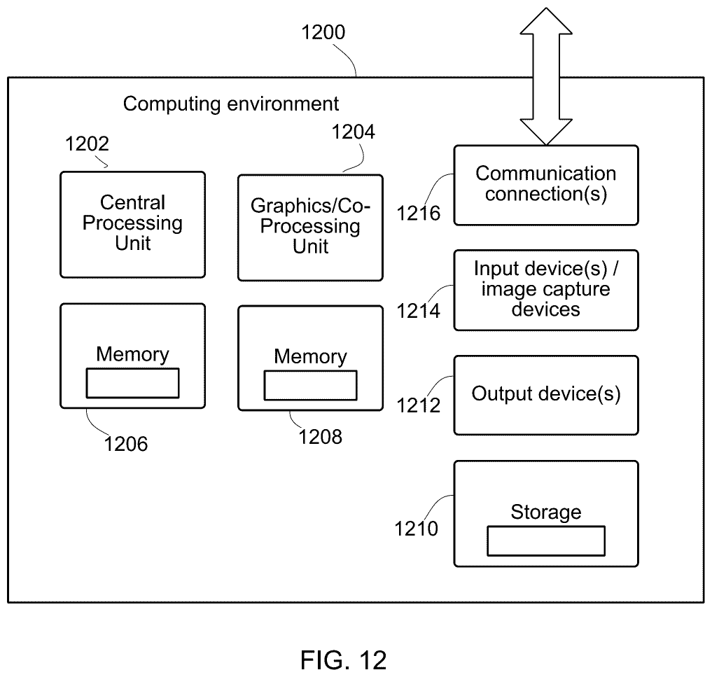

FIG. 12 illustrates a block diagram of an exemplary computing environment 1200 for an implementation of an RPA system, such as the RPA systems disclosed herein. The embodiments described herein may be implemented using the exemplary computing environment 1200. The exemplary computing environment 1200 includes one or more processing units 1202, 1204 and memory 1206, 1208. The processing units 1202, 1206 execute computer-executable instructions. Each of the processing units 1202, 1206 can be a general-purpose central processing unit (CPU), processor in an application-specific integrated circuit (ASIC) or any other type of processor. For example, as shown in FIG. 12, the processing unit 1202 can be a CPU, and the processing unit can be a graphics/co-processing unit (GPU). The tangible memory 1206, 1208 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1200 may be rearranged in various embodiments, and some embodiments may not require nor include all of the above components, while other embodiments may include additional components, such as specialized processors and additional memory.

The exemplary computing environment 1200 may have additional features such as, for example, tangible storage 1210, one or more input devices 1214, one or more output devices 1212, and one or more communication connections 1216. An interconnection mechanism (not shown) such as a bus, controller, or network can interconnect the various components of the exemplary computing environment 1200. Typically, operating system software (not shown) provides an operating system for other software executing in the exemplary computing environment 1200, and coordinates activities of the various components of the exemplary computing environment 1200.

The tangible storage 1210 may be removable or non-removable, and includes magnetic disks, magnetic tapes or cassettes, CD-ROMs, DVDs, or any other medium which can be used to store information in a non-transitory way, and which can be accessed within the computing system 1200. The tangible storage 1210 can store instructions for the software implementing one or more features of a PRA system as described herein.

The input device(s) or image capture device(s) 1214 may include, for example, one or more of a touch input device (such as a keyboard, mouse, pen, or trackball), a voice input device, a scanning device, an imaging sensor, touch surface, or any other device capable of providing input to the exemplary computing environment 1200. For multimedia embodiment, the input device(s) 1214 can, for example, include a camera, a video card, a TV tuner card, or similar device that accepts video input in analog or digital form, a microphone, an audio card, or a CD-ROM or CD-RW that reads audio/video samples into the exemplary computing environment 1200. The output device(s) 1212 can, for example, include a display, a printer, a speaker, a CD-writer, or any another device that provides output from the exemplary computing environment 1200.

The one or more communication connections 1216 can enable communication over a communication medium to another computing entity. The communication medium conveys information such as computer-executable instructions, audio or video input or output, or other data. The communication medium can include a wireless medium, a wired medium, or a combination thereof.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

1. A computer-implemented method for automating a process, the method comprising:
recording user actions performed on at least one software application, wherein at least some of the user actions involve interaction with a user interface (UI) control element of the at least one software application;
for each of a plurality of the user actions that involves an interaction with a UI control element, generating one or more fallback element locators for the corresponding UI control element;
subsequently initiating running of an automation program, wherein the automation program programmatically performs at least some of the user actions that were recorded;
determining a failed automation attempt by the automation program to interact with at least one of the UI control elements of the at least one software application;
retrieving at least one of the fallback element locators for the at least one of the UI control elements of the at least one software application corresponding to the failed automation attempt; and
retrying, in accordance with the retrieved at least one of the fallback paths, the failed automation attempt by the automation program to interact with the at least one of the UI control elements of the at least one software application corresponding to the failed automation attempt.

2. A computer-implemented method as recited in claim 1, wherein the generating of the one or more fallback element locators comprises:
generating a fallback path based on an UI element that precedes the at least one UI control elements of the at least one software application corresponding to the failed automation attempt.

3. A computer-implemented method as recited in claim 1, wherein the generating of the one or more fallback element locators comprises:
generating a fallback path that identifies an UI object that is a sibling of the at least one UI control elements of the at least one software application corresponding to the failed automation attempt.

4. A computer-implemented method as recited in claim 1, wherein the generating of the one or more fallback element locators comprises:
generating a fallback path based on one or more attributes of the at least one UI control elements of the at least one software application corresponding to the failed automation attempt.

5. A computer-implemented method as recited in claim 1, wherein the generating of the one or more fallback element locators comprises:
generating a fallback path that identifies the position of the at least one of the UI control elements of the at least one software application corresponding to the failed automation attempt relative to its top-most parent.

6. A computer-implemented method as recited in claim 1, wherein the generating of the one or more fallback element locators comprises:
generating a fallback path based on at least one cascading style sheet (CSS) parameter associated with the at least one of the UI control elements of the at least one software application corresponding to the failed automation attempt.

7. A computer-implemented method as recited in claim 1, wherein the method comprises:
validating the retrieved at least one fallback path based on a threshold number of parameters for an UI element that the retrieved at least one fallback path identifies matches parameters of the at least one of the UI control elements of the at least one software application corresponding to the failed automation attempt.

8. A computer-implemented method as recited in claim 1,
wherein the recording of the user actions includes at least recording metadata related to that at least the user actions involve interaction with a user interface (UI) control element of the at least one software application, and
wherein the method comprises:
validating the retrieved at least one fallback path based on at least a portion of the recorded metadata.

9. A computer-implemented method for automating a process, the method comprising:
recording, by a recorder module, one or more user actions performed on a software application where at least some of the user actions involve interaction with a user interface (UI) control element of the software application;
for each user action that involves an interaction with a UI control element, generating, by a fallback XPath generator module, one or more fallback XPaths for the UI control element;
prioritizing the one or more generated fallback XPaths according to the likelihood that each of the generated fallback XPaths correspond to a particular UI control element of the software application that the user interacted with; and
storing the one or more generated fallback XPaths within a repository with or in accordance with priority information.

10. A computer-implemented method as recited in claim 9, wherein generating the fallback XPath comprises:
generating a fallback XPath based on an HTML element that precedes the particular UI control element that the user interacted with.

11. A computer-implemented method as recited in claim 9, wherein generating the fallback XPath comprises:
generating a fallback XPath that identifies an HTML object that is a sibling of the particular UI control element that the user interacted with.

12. A computer-implemented method as recited in claim 9, wherein generating the fallback XPath comprises:
generating a fallback XPath based on one or more attributes of the particular UI control element that the user interacted with.

13. A computer-implemented method as recited in claim 9, wherein generating the fallback XPath comprises:
generating a fallback XPath that identifies a position of the particular UI control element that the user interacted with relative to its top-most parent.

14. A computer-implemented method as recited in claim 9, wherein generating the fallback XPath comprises:
generating a fallback XPath based on at least one cascading style sheet (CSS) parameter associated with the particular UI control element that the user interacted with.

15. A computer-implemented method as claimed in claim 9, comprising:
prioritizing a first fallback XPath based on an HTML element that precedes the particular UI control element that the user interacted with higher than a second fallback XPath that identifies an HTML object that is a sibling of the particular UI control element that the user interacted with.

16. A computer-implemented method as claimed in claim 9, comprising:
running an automation program, wherein the automation program programmatically performs at least some of the same actions performed by the user by interacting with UI control elements in one or more software applications;
determining a failed automation attempt by the automation program to interact with one of the UI control elements;
retrieving at least one of the fallback XPaths for the UI control element corresponding to the failed automation attempt; and
validating the at least one retrieved fallback XPath by determining that a threshold number of parameters for a HTML object that the fallback XPath identifies matches parameters of the particular UI control element with which the user interacted with.

17. A computer-implemented method for automating a process, the method comprising:
determining that an automation operation of an automation process has failed to identify a target user interface (UI) element within a software application user interface, wherein the automation program is configured to interact with the target UI element in order to carry out the automation operation;
extracting, by a user interface code extraction module, code of the software application UI;
identifying, by a relevant UI code identifying module, one or more relevant portions of the extracted code of the software application that are more likely to represent the target UI element;
generating prompt messages, by a prompt generating module, that incorporate at least the identified relevant portions of the extracted code, where the prompt messages provide instructions to an XPath generating machine learning (ML) model that is configured to generate XPaths, wherein each of the generated XPaths identifies a candidate target UI element;
validating, using an XPath validation module, at least one of the generated XPaths; and
resuming the automation operation using at least one of the validated XPaths, wherein the automation program identifies the target UI element using the at least one of the validated XPath.

18. A computer-implemented method for automating a process as recited in claim 17, wherein the identifying one or more relevant portions of the extracted code of the software application comprises:
identifying one or more input fields that follow a predetermined text value.

19. A computer-implemented method for automating a process as recited in claim 17, wherein the identifying one or more relevant portions of the extracted code of the software application comprises:
identifying one or more UI elements having a parent and of a sibling relationship with respect to a UI element with which a user interacted during a design phase of the automation program.

20. A computer-implemented method for automating a process as recited in claim 17, wherein the identifying one or more relevant portions of the extracted code of the software application comprises:
identifying one or more UI elements having a predetermined number of UI element parameters that match UI element parameters of a UI element with which a user interacted during a design phase of the automation program.

21. A computer-implemented method for automating a process as recited in claim 17, wherein the generating prompt messages comprises generating instructions to the XPath generating machine learning (ML) model to perform the following operations:
identify a first set of candidate UI elements, wherein the first set of candidate UI elements comprises one or more input field UI elements within the software application user interface that appear after a predetermined text value;
out of the first set of candidate UI elements, identify a second set of candidate UI elements where the second set of candidate UI elements comprises input field UI elements that have one or more UI element parameters that match the UI element parameters of a UI element with which a user interacted during a design phase of the automation program; and
generate an XPath for each of the candidate UI elements within the second set of candidate UI elements.

22. A computer-implemented method for automating a process as recited in claim 5 wherein the generating prompt messages comprises generating instructions to the XPath generating machine learning (ML) model to perform the following operations:
when identifying the second set of candidate UI elements fails to identify any candidate UI elements, identify a third set of candidate UI elements, wherein the third set of candidate UI elements comprises input field UI elements that have at least one UI element parameters that match the UI element parameters of a UI element with which a user interacted during a design phase of the automation program.
